(19) United States
(12) Patent Application Publication
(10) Pub. No.: US 2005/0083535 A1
(43) Pub. Date: Apr. 21, 2005

(54) Detection of transient phase shifts in any optical wave front with photorefractive crystal and polarized beams

(76) Inventors: Alexei A Kamshilin, Helsinki (FI); Alexander Grachev, St. Petersburg (RU)

Correspondence Address: Walter A Hackler;Patent Law Office, 2372 S E Bristol Street, Suite B, Newport Beach, CA, 92660-0755, US

(21) Appl. No.: 10/496,149

(22) PCT Filed: Nov. 27, 2001
(86) PCT No.: PCT/US01/45060

(51) Int. Cl. G01B 9/02

(52) U.S. Cl. 356/502

(57) ABSTRACT

Detecting transient phase shifts in an object laser beam of predetermined frequency having an arbitrary wavefront and apparatus for directing said object laser beam to cross a second reference laser beam coherent with said object beam into an oriented photorefractive crystal (22) (Bi12TiO20) (applied alternating electric field) belonging to the crystal symmetry group of 43m or 23, setting the polarization state of said object beam (20, 26) and said reference beams (32, 34) to be elliptical and different one from other, causing said object laser beam to interfere with said reference beam inside the said photorefractive crystal so as to form a dielectric-permittivity-tensor grating diffracting said reference beam into said object beam and vice versa, and directing a beam transmitted through the said photorefractive crystal in the direction of a transmitted object beam onto a photo-detector (44) to result in an electrical output signal that is representative of the transient phase shift in the object laser beam. Optical fibers and splitted object beams may be used.

### FIELD OF INVENTION

The present invention relates to a method and apparatus for detecting a transient phase shift in any optical wavefronts. The invention is particularly directed toward detecting ultrasonic motion of a diffusely scattering or reflecting surface, which is very useful for remote nondestructive testing applications. Moreover, the invention is directed toward the measurements of small phase shifts of a complicated wavefront arising from a multimode optical fiber when it is subjected to bending, pressure, or another impact providing that such phase shift is representative of this impact.

### BACKGROUND OF INVENTION

The detection of the phase modulation or frequency modulation of an optical wave is important for various fields of application where optical beams are used to detect the motion of the objects. This is the case of laser sensing of vibrations and laser detection of ultrasound and of transient body deformations such as those produced by a shock or on impact. Unlike transducer-based systems, optical detection is noncontacting, thus allowing inspection of parts at high temperatures or in hazardous environment. In addition, the laser beams can be scanned rapidly over curved surfaces, thus increasing the rate of inspection.

Several interferometric methods and apparatus are known to transfer a phase (or frequency) modulation of a light wave to a light power modulation by combining the phase-modulated object beam with the reference one, and further detection of light power modulation by means of a photo-receiver unit. Since in many cases, the modulation excursions to be detected are very small, sensitivity of an interferometer is a prime concern.

The use of two-wave mixing in photorefractive crystals for achievement of high sensitivity in the case of arbitrary wavefront of the object beam is well known. In this method, an arbitrary signal beam reflected or refracted by the object is combined with the plane-wave reference beam to interfere in a dynamic medium such as a photorefractive crystal and to form a real-time hologram in the crystal. Both beams are simultaneously diffracted from this real-time hologram so that a non-diffracted part of the object beam and a diffracted part of the reference beam have identical wavefronts and propagate in the same direction. Consequently, the photorefractive crystal acts as a self-adjusted beam combiner providing holographic adaptation of the object-beam wavefront with that of the reference beam.

To achieve the highest rate of the phase-to-intensity transformation, the two-wave mixing process requires in the ideal case a π/2 difference between the phases of the two interfering wavefronts (object and reference) incident on the photo-receiver (quadrature condition). The phase shift between diffracted part of the reference beam and non-diffracted part of the object beam is defined by the physical mechanism of the real-time hologram formation. If the hologram is recorded without application to the crystal of an external electric field (diffusion mechanism of recording), this phase shift is equal either 0 or π, which is the least sensitive to phase modulation. When recording is performed under a strong DC electric field applied to the crystal (drift mechanism), this phase shift is approaching to π/2 thus providing the quadrature conditions of the most sensitive detection of phase excursions (S. I. Stepanov, “Application of photorefractive crystals,” Rep. Prog. Phys., vol. 57, pp. 39-116, 1994).

It is also known that a real-time hologram recording in the diffusion mode leads to amplification of the object beam in expense of the reference beam. In contrast, there is no object-beam amplification when the quadrature conditions are achieved. Moreover, it was shown that even for the intermediate phase shift (0<φ<π/2) between the diffracted and non-diffracted parts, the sensitivity to phase disturbance does not depend on the gain of the object beam (P. Delaye, A. Blouin, D. Drolet, L.-A. de Montmorillon, G. Roosen, and J.-P. Monchalin, “Detection of ultrasonic motion of a scattering surface using photorefractive InP:Fe under an applied dc field,” J. Opt. Soc. Am. B, vol. 14, pp. 1723-1734, 1997).

In order to provide sensitive transformation of a phase modulation into an intensity modulation it has already been proposed in U.S. Pat. No. 5,131,748 (J.-P. Monchalin and R. K. Ing, “Broadband optical detection of transient motion from a scattered surface by two-wave mixing in a photorefractive crystal,” U.S. Pat. No. 5,131,748 (1992)) to introduce an external temporal phase or frequency shift into one of the interfering beams while the hologram is recorded in the diffusion mode. However, such a phase shift affects on the hologram formation that leads to decreasing of the hologram efficiency and consequently, to a worse sensitivity.

Another method allowing achievement of the quadrature conditions when the hologram is recorded under diffusion mechanism has also been disclosed in U.S. Pat. No. 5,131,748 and described in the open literature (R. K. Ing and J.-P. Monchalin, “Broadband optical detection of ultrasound by two-wave mixing in a photorefractive crystal, ” Appl. Phys. Lett., vol. 59, pp. 3233-3235, 1991). In this method, input polarization states of the interfering beams are linear but different one from another so as at the input face of the photorefractive crystal the reference beam has a single polarization component parallel to one of the two principal axis of the crystal, but the object beam has two polarization components directed along both axes. After being emerged from the crystal, diffracted part of the reference beam and nondiffracted part of the object beam are transmitted through a properly oriented phase retardation plate and then are enforced to interfere along new axes by a properly oriented polarization cube beam splitter. However, the sensitivity of this method is diminished because of the optical energy loss from the polarization analyzer.

The polarization filtering of the coherent mixture of the transmitted and diffracted parts of the beams emerged from the photorefractive crystal of cubic symmetry has been used in the polarization self-modulation method (A. A. Kamshilin, K. Paivasaari, M. B. Klein, and B. Pouet, “Adaptive interferometer using self-induced electrooptic modulation,” Appl. Phys. Lett., vol. 77, pp. 4098-4100, 2000; K. Paivasaari, A. A. Kamshilin, V. V. Prokofiev, B. I. Sturman, G. F. Calvo, M. Carrascosa, and F. Agullo-Lopez, “Linear phase demodulation in photorefractive crystals with non-local response,” J. Appl. Phys., vol. 70, pp. 3135-3141, 2001). In this method, an alternating electric field with the repetition frequency higher than the reciprocal response time of the crystal was applied to the properly oriented photorefractive crystal and the properly oriented polarization analyzer was installed after the crystal. Polarization states of the interfering beams were identical and linear. A real-time hologram created under such rapidly varying external electric field has the same phase shift compare to the input interference pattern as a hologram recorded in the diffusion mode, thus resulting in amplification of the signal beam. The birefringence induced by the external electric field enforces the polarization components of the diffracted and non-diffracted parts interfere in the quadrature conditions. However, the sensitivity is again limited by inevitable loss of the optical light energy in the polarization analyzer.

It is therefore an object of the present invention to provide a method and apparatus for detection of transient phase shift in any optical wavefronts with the sensitivity to small phase perturbations higher than any known adaptive homodyne interferometer.

### SUMMARY OF THE INVENTION

According to one aspect of the invention, there is provided a method for detection a transient phase shift in an object laser beam of predetermined frequency having any optical wavefront, which generally includes the steps of:

a) setting the polarization state of the said object laser beam being elliptical with proper degree of ellipticity and with proper axes orientation in respect to the crystallographic axes of a photorefractive crystal, which belongs to the crystal symmetry group 23 or \overline{4}3m;

b) setting the polarization state of a second reference laser beam coherent with the said object laser beam being also elliptical but with the polarization state different from the polarization state of the said object laser beam;

c) directing said object laser beam together with said reference laser beam onto said photorefractive crystal, wherein said object and said reference beams are made co-propagating and with superposed wavefronts; and

d) directing said co-propagating superposed object and reference laser beams onto a photodetector to result in an electrical output signal that is representative of the transient phase shift in the object laser beam.

The present invention also provides an apparatus for detection of the transient phase shift in any optical wavefronts, which generally includes a laser source for generating a laser beam with a predetermined frequency and an optical assembly for deriving two mutually coherent beams, one of which serves as a reference beam and another an object beam interacting with an object, for example by means of scattering or reflecting, to obtain a transient phase shift, for collecting the object and reference beams into the photorefractive crystal, and for causing the reference beam to interfere inside the photorefractive crystal with the object beam. The apparatus further includes a phase retardation optical element installed at least in one of the said beams for setting the proper polarization state and an optical assembly for collecting a beam, which is combined of the partially transmitted object beam and partially diffracted reference beam, into an optical detector for detecting the optical signal and converting it into an electrical signal representative of a transient phase shift. The apparatus may also includes a power supply for producing of an alternating electric voltage varying in time with a period shorter than the response time of the photorefractive crystal to apply to the photorefractive crystal so as to increase the strength of the dielectric-permittivity-tensor grating.

Photorefractive crystals are optical materials in which electrical charges can be released from their initial localized sites by photo-excitation and then trapped at other sites, thus producing a local electrical charge variation in the case of spatially nonuniform light illumination. This charge variation then creates an electric field, the spatial distribution of which corresponds to the three-dimensional intensity distribution of the incident optical pattern. Photorefractive crystals of the symmetry groups 23 and \overline{4}3possess the linear electrooptic effect. Therefore, the space-charge electric field results in the spatial modulation of the dielectric-permittivity tensor of the crystal. When the incident optical pattern is a result of the interference between two mutually coherent beams, these beams are diffracted from the self-created grating of the dielectric-permittivity tensor so as the partially transmitted object beam and partially diffracted reference beam are co-propagating in one direction being emerged from the crystal. The holographic combination of these beams insures that they have precisely overlapped wavefronts irrespectively on complexity of the incident wavefronts. It is well known that the dielectric-permittivity-tensor grating created in a photorefractive crystal without external electric field or under a fast varying alternating electric field is π/2-phase shifted in respect with the input interference pattern. This has the consequence that the transmitted part of the object beam is in phase with the diffracted part of the reference beam and therefore the sensitivity to a small transient phase shift is nearly zero (J.-P. Monchalin and R. K. Ing, “Broadband optical detection of transient motion from a scattered surface by two-wave mixing in a photorefractive crystal,” U.S. Pat. No. 5,131,748 (1992); S. I. Stepanov, “Application of photorefractive crystals,” Rep. Prog. Phys., vol. 57, pp. 39-116, 1994). This is correct only when the interfering beams have the same polarization state, which is typical for the most of the interferometric methods.

Applicant has found quite unexpectedly that small phase perturbations of the object beam still can be detected in a photorefractive crystal with the dielectric-permittivity-tensor grating recorded in the diffusion regime if the interfering beams have elliptical polarization states, which differs one from another.

Such a condition can be fulfilled, for example, by setting the polarization state of the reference beam being circular and the polarization state of the object beam being linear. If the grating is formed without electric field, an optimum orientation is achieved when the object and reference beams propagate under small angle to the crystallographic axis <110> of a photorefractive crystal without optical activity forming the interference pattern with the fringes perpendicular to the axis <\overline{1}10>, while the linear polarization of the object beam is parallel to the same axis <\overline{1}10> and the reference beam is circularly polarized. When the grating is created under an alternating electric field, an optimal polarization states and the crystal orientation can be either theoretically calculated using vectorial coupled-wave equations or found experimentally.

The invention is particularly useful for detecting small surface deformations or displacements of a material subjected to ultrasonic energy, enabling displacements ranging from a fraction of 1 Å to a few hundred of Å to be detected from any rough surface and with a broad frequency bandwidth.

### DESCRIPTION OF THE DRAWINGS

Further features and advantages of the invention will be better understood from the following description of preferred embodiments as illustrated by way of examples in the accompanying drawings in which:

FIG. 1 is a schematic view showing diagrammatically the paths of the object and reference laser beams through a photorefractive crystal up to a photodetector;

FIG. 2 is a schematic perspective view of a photorefractive crystal showing polarization states of the interfering beams and orientation of the crystal according to the invention;

FIG. 3 illustrates an improvement of the embodiment shown in FIG. 1, incorporating the generator of alternating electric voltage;

FIG. 4 shows a plot (a) showing the minimum detectable wavefront displacement of the adaptive interferometer normalized to that of the classical interferometer as a function of the external field for linearly polarized object beam and circularly polarized reference beam and plot (b) similar to (a) but for elliptically polarized object beam and linearly polarized reference beam;

FIG. 5 shows a plot (a) of the amplification gain of the object beam as a function of the external field calculated using the same parameters as in FIG. 4 (a) and a plot (b) of the amplification gain of the object beam as a function of the external field calculated using the same parameters as in FIG. 4 plot (b);

FIG. 6a shows the input polarization states used for calculations of plots in FIGS. 4a and 5a;

FIG. 6b shows the input polarization states used for calculations of plots in FIGS. 4b and 5b;

FIG. 6c shows the input polarization states leading to the same minimal detectable phase shift at the external electric field of 20 kV/cm as the polarization states of FIG. 6b;

FIG. 7 illustrates an optical scheme similar to FIG. 3 but including a multimode fiber for introducing a complex wavefront, said multimode fiber being subjected to acoustic or ultrasonic vibrations;

FIG. 8 shows modification of the optical schemes of FIGS. 1, 3, and 7 that exploits a feature of counter-phase intensity modulation for orthogonally polarized parts of the object beam and allows effective suppression of amplitude noise of the laser source;

FIG. 9 shows a plot (a) (left ordinate) of the signal-to-noise ratio of a Bi₁₂TiO₂₀ photorefractive crystal as a function of the external electric field and a plot (b) (right ordinate) of the amplification gain of the object beam as a function of the external electric field measured for the same crystal;

FIG. 10 shows an oscilloscope trace of the electrical signal from the photo-detector when the square-wave alternating electric field is applied to the crystal; and

FIG. 11 shows an oscilloscope trace of the electrical signal from the photo-detector (trace a) for the case of a sinusoidal external electric field (trace b) applied to the crystal.

### DESCRIPTION OF THE PREFERRED EMBODIMENT

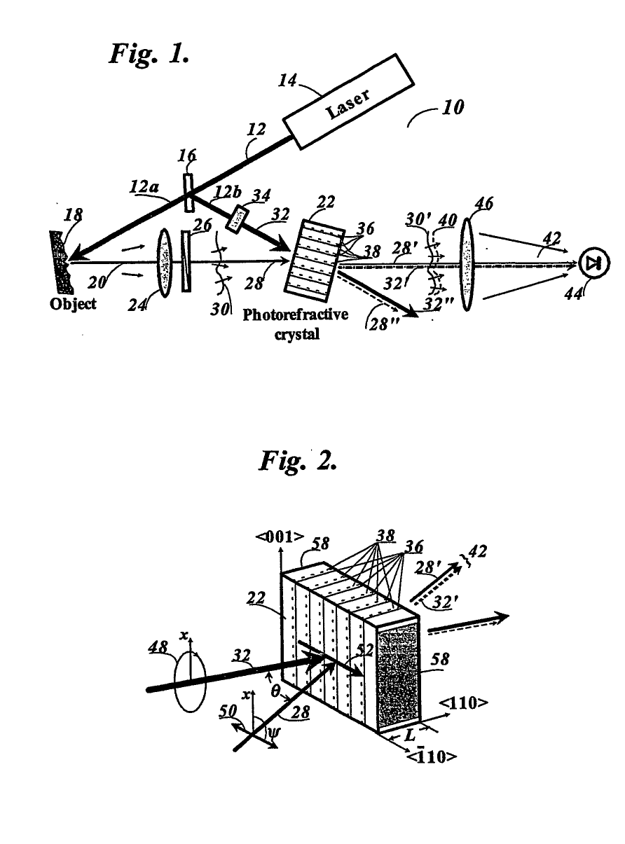

FIG. 1 illustrates a preferred embodiment 10 according to the invention in which the reference beam is circularly polarized, the object beam is linearly polarized and no electric field is applied to the crystal. As shown, a linearly-polarized laser beam 12 generated by a laser source 14 is divided by a beamsplitter 16 into two mutually coherent parts 12a and 12b. The beam part 12a is directed onto the surface 18 which can be subjected to acoustic (low frequency) or ultrasonic (high frequency) energy. Sonic displacements of the surface 18 lead to a transient phase shift of the scattered (or reflected) beam 20. Scattered light 20 is collected into a photorefractive crystal 22 by means of a lens 24 or by another way, using, for example, prisms, mirrors, or optical waveguides or their combinations (not shown). The photorefractive crystal may be, for example, but not limited to Bi₁₂TiO₂₀ belonging to the 23 group of symmetry. A polarizing optical element 26 installed before the photorefractive crystal 24 ensures the linear polarization of the object beam 28. Finally, the object beam 28 impinged on the entrance face of the photorefractive crystal 22 is phase modulated and it has an arbitrary wavefront schematically shown in FIG. 1 by a curve 30.

The reference beam 32 is formed from a laser beam part 12b transmitted through a phase-retardation optical element 34 (a quarter-wave phase plate), which is adjusted so as the reference bean becomes circularly polarized. The reference beam 32 is directed into the same photorefractive crystal 22 where it intersects the object beam 28.

Mutually coherent object and reference beams 28, 32 interfere inside the photorefractive crystal 28 to form an interference pattern, the spatial position of the intensity maxima in the interference pattern is schematically shown by solid lines 36. This interference pattern creates a space-charge-field grating inside the photorefractive crystal, which spatially modulates the dielectric-permittivity tensor of the crystal. Owing to the diffusion mechanism of the grating formation, the lines of the maximal dielectric-permittivity changes, which are schematically shown by dashed lines 38, are shifted from the interference pattern fringes by a quarter of the spatial period.

While propagating through the photorefractive crystal 22 with recorded dielectric-permittivity-tensor grating 38, both the reference and object beam diffracted from the grating. Therefore, the light beam emerged from the crystal in the direction of the transmitted object beam is a composite or superposition of the partially transmitted object beam 28′ and the partially diffracted reference beam 32′. The holographic combination of the object and reference beams insures that they have identical wavefronts that are shown schematically by curves 30′ and 40, respectively. The co-propagating partially transmitted beam 28′ and partially diffracted beam 32′ together comprise the combined beam 42 that is collected into a photodetector 44 by means of a lens 46 or by another way, using, for example, prisms, mirrors, or optical waveguides or their combinations (not shown). The intensity of the combined beam 42 measured by the photodetector 44 is representative of the transient phase shift between the reference and object beams 28, 32.

Similarly, the light beam emerged from the crystal in the direction of the transmitted reference beam is a superposition of the partially transmitted reference beam 32″ and the partially diffracted object beam 28″. The intensity of this combination also represents the transient phase shift.

FIG. 2 shows in details the perspective view of the photorefractive crystal 22 with the input object and reference beams 28, 32. The crystal is cut so that the input face of the crystal is the crystallographic surface (\overline{1}10), which is orthogonal to the axis <110>. The polarization state of the reference beam is circular as schematically shown by a circle 48, while the polarization state of the object beam is linear as schematically shown by an arrow 50 and it makes an angle ψ with the axis x, which is parallel to the axis <001>. The object and reference beams are directed on the photorefractive crystal so as a plane containing average propagation directions of both the object and reference beams inside the crystal is orthogonal to the crystallographic axis <001>, which makes the vector of the dielectric-permittivity-tensor grating 52 being parallel to the axis <\overline{1}10>. Other crystal cuts can be used as well, however, the highest transformation rate of the phase-to-intensity modulation is achieved in the cut shown in FIG. 2.

The separate beams 28′, 32′ have different polarization states that are defined by the input polarization states of the beams 28, 32 and by the orientation of the dielectric-permittivity-tensor grating in respect to the crystallographic axes of the crystal 22. Intensity of the beam 42 is defined by the vectorial sum of the amplitudes of the beams 28′ and 32′ and it depends on both the phase shift between the interference pattern and the dielectric-permittivity-tensor grating and the transient phase shift between the input object and reference beams 28, 32.

When the crystal 22 is illuminated by the interference pattern, the formation of the space-charge field is not instantaneous but requires a specific time, τ_{R}, which depends on the material parameters of the crystal, on the light wavelength, and on the light intensity. During and after creation of the space-charge field, the optical beams propagate and diffract from the dielectric-permittivity-tensor grating induced by the space-charge field. If the transient phase shift occurs faster than the response time τ_{R} of the space-charge formation, the optical beams is propagating in a “frozen” or fixed dielectric-permittivity-tensor grating.

Under the above-mentioned condition and suggesting that the grating's amplitude is almost independent on the coordinate along beams propagation direction, the polarization states and the amplitude of the transmitted and diffracted parts is calculated with help of the recently developed theory of vectorial wave coupling in cubic photorefractive crystal (B. I. Sturman, E. V. Podivilov, K. H. Ringhofer, E. Shamonina, V. P. Kamenov, E. Nippolainen, V. V. Prokofiev, and A. A. Kamshilin, “Theory of photorefractive vectorial wave coupling in cubic crystals,” Phys. Rev. E, vol. 60, pp. 3332-3352, 1999). For photorefractive crystals oriented as shown in FIG. 2, applicant has found an analytical dependence of the intensity of the beam 42 on the transient phase shift δφ between the linearly polarized object beam and the circularly polarized reference beam, when the hologram is formed without external electric field (diffusion mechanism of recording):

$$\frac{{I}_{out}}{{I}_{O} {ⅇ}^{- α L}} = {cos}^{2} ( qL ) + \frac{{ρ}^{2} + R {κ}^{3}}{{q}^{3}} {sin}^{2} ( qL ) - \frac{κ \sqrt{2 R} sin ( qL )}{q} [ cos ( qL ) sin ( 2 ψ - δ ϕ ) + \frac{ρ}{q} sin ( qL ) cos ( 2 ψ - δ ϕ ) ] . \qquad ( 1 )$$

Here θ is a coupling constant of the interfering beams,

$$κ = \frac{\sqrt{2 R}}{R + 1} \frac{π {n}_{0}^{3} {r}_{41}}{λ} \frac{{k}_{B} T}{e} \frac{4 π}{λ} sin ( \frac{θ}{2} ) , \qquad ( 2 )$$

Iₒ is the input intensity of the object beam, R is the intensity ratio of the input reference to the input object beam, L is the crystal thickness, λ is the laser wavelength, n₀ is the refractive index of the crystal, α is the absorption coefficient of the crystal, ρ is the optical rotatory power (for optically active crystals), r₄₁ is the electrooptic coefficient, θ is the average angle between the reference and object beams, k_{B} is the Boltzmann constant, T is the temperature of the crystal, e is the electron's charge, and q=\sqrt{ρ²+κ²}. It follows from Eq. 1 that the intensity variation Iₒᵤₜ(δφ)−Iₒᵤₜ(0) is proportional to sin(δφ), when the polarization plane of the object beam makes an angle ψₒₚₜ defined by the equation:

$$tan ( 2 {ψ}_{opt} ) = - \frac{ρ}{\sqrt{{ρ}^{2} + {κ}^{2}}} tan ( L \sqrt{{ρ}^{2} + {κ}^{2}} ) . \qquad ( 3 )$$

Therefore, small transient phase shifts, δφ<<1, are linearly transferred into the output intensity modulation, when the reference beam is circularly polarized and the object beam is linearly polarized under the angle ψₒₚₜ in respect to the crystallographic axis <001>. It occurs even in the case, when the dielectric-permittivity-tensor grating is shifted from the interference pattern by a quarter of the period. In spite of the fact that the equations (1)-(3) were obtained for the interfering beams with plane wavefronts, the above conclusion is also true in the case of the interfering beams with any complicated wavefronts.

For crystals of the symmetry group \overline{4}3m (without optical activity, ρ=0), the expression for the intensity of the superposed beam 40 can be further simplified:

$$\frac{{I}_{out}}{{I}_{O} {ⅇ}^{- α L}} = {cos}^{2} ( κ L ) + R {sin}^{2} ( κ L ) - \sqrt{\frac{R}{2}} sin ( 2 κ L ) sin ( 2 ψ - δ ϕ ) . \qquad ( 4 )$$

As one can see, for crystals of \overline{4}3m-symmetry, the highest rate of the phase-to-intensity transformation is achieved at either ψ=0 or ψ=π/2.

Applicant has found that the Equations (1)-(4) remain the same if the object beam is circularly polarized and the reference beam is linearly polarized under the angle ψ in respect to the crystallographic axis <001>.

Note that in the case of the equal polarization states (either linear or elliptical) of the reference and object beams, the intensity variation of the superposed beam 42 is always proportional to cos(δφ), which makes the interferometer being the least sensitive to small transient phase shifts.

The theoretical analysis, based on the vectorial approach to the light diffraction from a grating recorded in a photorefractive crystal without external electric field, shows that in an arbitrarily oriented crystal, a pair of the different polarization states for the object and reference beam providing linear phase-to-intensity transformation can be always found. However, an optimal geometry of beam interaction (that leads to the highest sensitivity to small transient phase shifts) is achieved in the configuration shown in FIG. 2 when the polarization plane of the linearly polarized beam makes the angle ψ in respect to the axis <001> defined by Eq. 3.

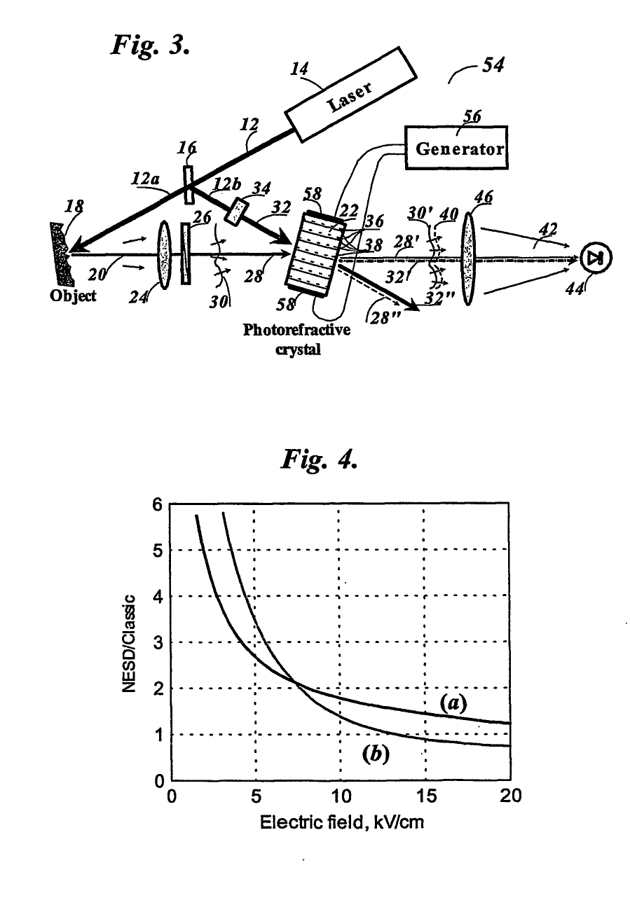

FIG. 3 shows an optical scheme 54, which is an improvement of the preferred embodiment 10 of the invention in which alternating electric field with the repetition frequency higher than the reciprocal response time of the crystal is applied to the photorefractive crystal. It is done by means of a generator 56 output of which is electrically connected with the crystal 22. The electrical connection can be realized for example with help of electrodes 58 evaporated on the side faces of the photorefractive crystal as shown in FIG. 2. The highest influence of the external electric field on the amplitude of the dielectric-permittivity-tensor grating is achieved when the electric field is parallel to the grating vector. In the geometry shown in FIG. 2, this optimum corresponds to the electrodes 58 orthogonal to the axis <\overline{1}10>. Common reference characters in FIG. 3 represent identical or similar elements shown in FIG. 1.

As explained by S. I. Stepanov and M. P. Petrov (S. I. Stepanov and M. P. Petrov, “Efficient unstationary holographic recording in photorefractive crystals under an external alternating electric field,” Opt. Commun., vol. 53, pp. 292-295, 1985), such an alternating electric field significantly increases the amplitude of the spatial dielectric-permittivity-tensor grating while it keeps the grating being spatially shifted from the input interference pattern by a quarter of the period. This shift is optimal for enhancement of the object beam in the expense of the reference beam. However, the linear phase-to-intensity transformation cannot be achieved in the case when the reference and object beams have the same input polarization states.

Applicant has found quite unexpectedly that the power of the superposed beam 42 emerged from the crystal is larger than the power of the input object beam while ability of the linear phase-to-intensity transformation is preserved.

A key parameter that allows different homodyne interferometers to be compared is the signal-to-noise ratio (SNR) of the electrical signal generated by the photodetector, which is representative of the transient phase shift δφ. SNR defines the smallest transient displacement of the object wavefront that can be detected above the noise level for a defined detection bandwidth and for a defined power level on the photodetector. As expected from the principles of coherent homodyne detection, the signal is proportional to the amplitude of the light power modulation at the photodetector caused by the phase modulation of the object beam. Considering that we operate in the photon noise limited regime (electronic noise is negligible and the laser beam power fluctuations are photon noise limited), the noise is proportional to the square root of the average number of photons reached the photodetector.

Another commonly used parameter used to characterize a homodyne interferometer is the minimum detectable wavefront displacement expressed in Å times square root of W/Hz. It corresponds to the minimum detectable wavefront displacement (for which SNR=1) for a 1 W power of the object beam incident on the interferometer and a 1 Hz detection bandwidth.

We will compare performance of the interferometric method according to the invention with a classical homodyne interferometer without optical losses exploiting light beams with plane wavefronts. The minimum detectable wavefront displacement of the classical homodyne interferometer is

$${δ}_{CL} = \frac{λ}{2 π} \sqrt{\frac{hv}{2 η}} , \qquad ( 5 )$$

where hv is the photon energy and η is the quantum efficiency of the photodetector.

The expression for the intensity of the superposed beam 40 as a function of the transient phase shift (such as Eq. 1 or Eq. 4) is enough to calculate the minimum detectable wavefront displacement δ_{PTW} of the interferometric method according to the invention. However, derivation of the analytical expression for the case of the grating recording under an external alternating electric field is impossible because of the strong non-linearity of the grating formation process. Nevertheless, it is possible to solve numerically the system of the coupled differential equations, which describes vectorial light diffraction dielectric-permittivity-tensor grating in crystals of the cubic symmetry.

Applicant has solved numerically the system of the coupled wave equation derived by Sturman et. al. (B. I. Sturman, E. V. Podivilov, K. H. Ringhofer, E. Shamonina, V. P. Kamenov, E. Nippolainen, V. V. Prokofiev, and A. A. Kamshilin, “Theory of photorefractive vectorial wave coupling in cubic crystals,” Phys. Rev. E, vol. 60, pp. 3332-3352, 1999). The system was solved for the case when two light beams with different polarization states are coupled through a dielectric-permittivity-tensor grating self-recorded in a photorefractive crystal of cubic symmetry subjected to application of an alternating electric field of a square-wave form in the geometry shown in FIG. 2. This solution allows us to calculate SNR and, consequently, the minimum detectable wavefront displacement, δ_{PTW}. It was found that δ_{PTW} depends on the polarization states of the reference and object beams, their intensity ratio R, applied electric field, thickness of the crystal L, its absorption coefficient α, electro-optic coefficient r₄₁, and optical rotatory power ρ. The ratio δ_{PTW}/δ_{CL}, calculated under condition that the incident power of the object beam is the same for the classical interferometer and the interferometer according to the invention, is the best parameter for comparison of the interferometers performance.

For example, FIG. 4 shows the ratio δ_{PTW}/δ_{CL} as a function of the alternating electric field that was calculated using the parameters typical for a Bi₁₂TiO₂₀ crystal at λ=632.8 nm: α=1 cm⁻¹, ρ=6.5 deg/mm, r₄₁₌5.0 pm/V, L=4 mm, R=10. The curve (a) in FIG. 4 was calculated for the case when the reference beam is circularly polarized and the object beam is linearly polarized at ψ=15.3°, which is the optimal polarization-state pair for recording without external field in accordance with Eq. 3. One can see that the δ_{PTW} approaches to δ_{CL} when strong alternating field is applied to the crystal.

However, the optimal pair of the polarization states for the reference and object beams, which leads to the minimal δ_{PTW}, depends itself on the external electric field. For the crystal with the above-mentioned parameters, the optimal polarization states at the external field of 20 kV/cm were found as following. The reference beam is linearly polarized at ψ=−12° and the object beam is elliptically polarized with the ratio of small and big axes of the polarization ellipse (the ellipticity) equal to 0.178 and with the inclination angle of the big polarization axis in respect to the <001> equal to 82.3°. The curve (b) in FIG. 4 shows the ratio δ_{PTW}/δ_{CL} as a function of the external field calculated for this pair of the polarization states. One can see that the minimal detectable wavefront displacement δ_{PTW} becomes smaller than δ_{CL} when the alternating external field exceeds 13 kV/cm.

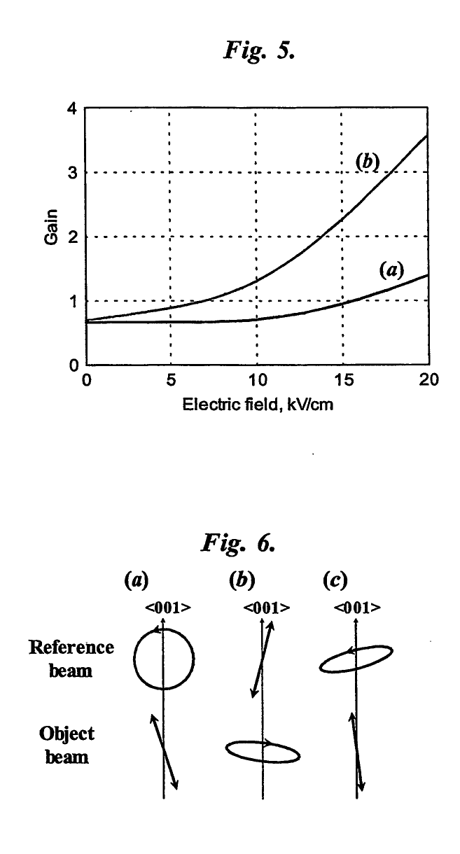

The reason of the higher sensitivity at higher external fields is amplification of the object beam power in expense of the reference beam. FIG. 5 shows the gain of the object beam, which is defined as the ratio of the power of the combined output beam 42 to the power of the input beam 28, as a function of the external electric field. Curves (a) and (b) in FIG. 5 were calculated for the same pairs of the input polarization states as the curves (a) and (b) in FIG. 4, respectively.

Applicant has also found another optimal pair of the input polarization states that leads to the same minimal value δ_{PTW} at the external electric field of 20 kV/cm as above. This is the linearly polarized object beam at ψ=6.5° and the elliptically polarized reference beam with the ellipticity of 0.198 and the inclination angle of −76.4°. All mentioned pairs of the polarization states are shown in FIG. 6.

External alternating electric field of any form can result in increasing of the amplitude of the dielectric-permittivity-tensor grating, if its repetition frequency is higher than the reciprocal response time of the crystal. The best increasing is achieved when it is of the square-wave form. However, sinusoidal alternating field can be easier generated. It is worth noting that the optimal pair of the input reference and object beams slightly depends on the alternating field form.

The optimal polarization-state pair. can also be found in an experiment independently varying the input polarization state of the reference and object beams so as to maximize SNR, which is proportional to the ratio of the intensity variation of the combined output beam 42 caused by the transient phase shift and the square root of the average intensity of the output beam 42 measured in absence of the transient phase shift.

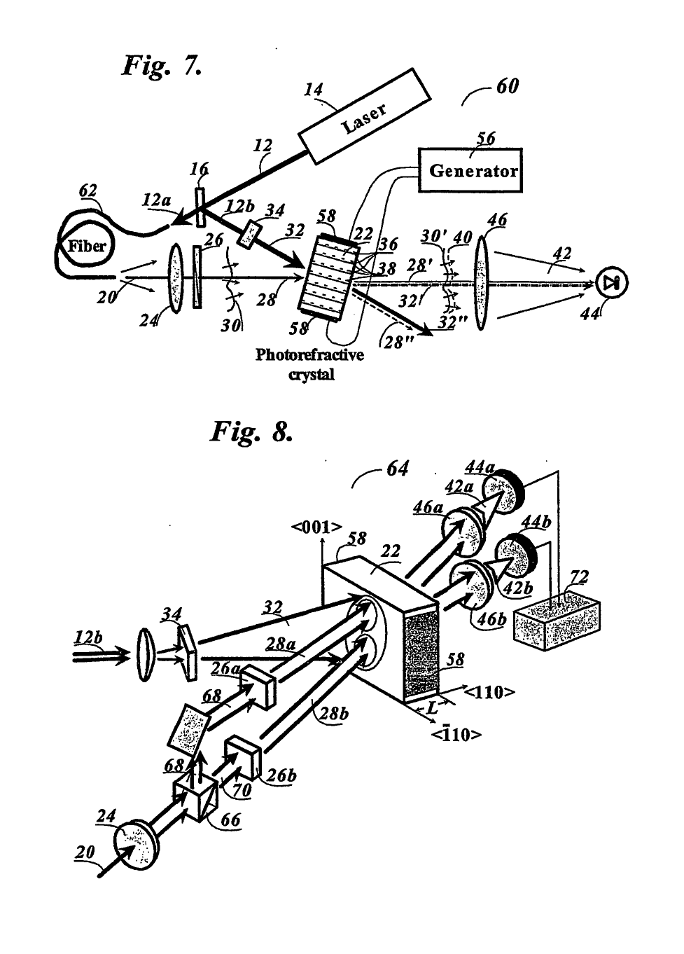

With reference to FIG. 7, embodiment 60, transient phase shift of the light wavefront occurs also when the light wave exits from an either multi-mode or single-mode fiber 62 subjected to acoustic or ultrasonic vibrations. Again, common reference characters in FIG. 7 represent identical or similar elements shown in FIGS. 1 and 3. The difference between embodiment 54, FIG. 3, and 60 is that the object beam 28 is launched in embodiment 60 into the fiber 62 and the output light from the fiber 62 is collected by the lens 24.

Analyzing dependences of the phase-to-intensity-transformation rate on the input polarization states of the interfering beams, applicant has found quite unexpectedly that there are two mutually orthogonal polarization states of the object beam, which create respectively two optimal pairs (leading to the highest rate of the phase-to-intensity transformation) with one and the same polarization state of the reference beam. Both the intensity modulation and the mean intensity are the same for these optimal pairs but the intensity of the combined beam 42 in one pair is modulated in counter phase compare to that of the other pair.

For example, in the case of the grating recording without external electric field, the highest rate of the phase-to-intensity transformation is achieved when the reference beam is circularly polarized and the object beam is linearly polarized with the plane of the polarization making the angle of either

$${ψ}_{opt}^{′} = \frac{1}{2} arctan [ - \frac{ρ}{\sqrt{{ρ}^{2} + {κ}^{2}}} tan ( L \sqrt{{ρ}^{2} + {κ}^{2}} ) ] or {ψ}_{opt}^{″} = {ψ}_{opt}^{′} + \frac{π}{2}$$

with respect to the axis <001>. The same highest rate is also achieved when the reference beam is linearly polarized under the angle of ψ′ₒₚₜ (or ψ″ₒₚₜ) and the object beam is either left-hand circularly polarized or right-hand circularly polarized. In both these examples, two optimal polarization states of the object beam are mutually orthogonal, and the intensity of the combined beam 42 for one optimal polarization is modulated in counter phase compare with other optimal polarization.

This specific feature can be used for effective suppression of the amplitude noise of the laser source as illustrated in the embodiment 64 of FIG. 8. Common reference characters in FIG. 8 represent identical or similar elements shown in FIGS. 1, 3, and 7.

The object beam 20 reflected from the test surface or transmitted trough the optical fiber is split into two beams 68, 70 with mutually-orthogonal linear polarization states and with almost equal light power by means of the polarization beam-splitter 66. If the object beam 20 is completely depolarized, this can be achieved at any position of the polarization beam-splitter 66. Otherwise, one can always find a proper orientation of the polarization beam-splitter that leads to beam splitting with almost equal light power. Further, each part of the object beam is transmitted through a polarization optical transformer 26a (26b) to set the optimal input polarization state for each part. Considering that the polarization states of the beams 68 and 70 are mutually orthogonal, one quarter-wave plate instead of two transformers 26a and 26b can be utilized for setting required mutually orthogonal polarization states of the object-beam parts 28a and 28b.

The beams 28a and 28b are directed into the photorefractive crystal 22 where they intersect the reference beam 32, which polarization state is set by the polarization transformer 34 (phase-retardation plate). Beams 28a and 28b can be directed either into the same or different areas of the entrance face of the photorefractive crystal 22. However, the second case is more preferable, because it avoids mutual diminishing of the respective dielectric-permittivity-tensor gratings. To accomplish this case, the reference beam 32 must be either expanded or split to overlap both beams 28a and 28b.

After formation of two dielectric-permittivity-tensor gratings by two pairs of the beams (28a with 32 and 28b with 32), two combined beams 42a and 42b are collected into a respective photo-detector 44a and 44b by means of a lens 46a and 46b. Electrical signal from the photodiodes 46a, 46b enters a processing circuit 72, which output signal is proportional to the difference of the input signals. Considering that the input electrical signals (which are proportional to the light power modulation entering into photo-detectors) are counter-phase modulated, the output signal will have double modulation amplitude around the zero level. Consequently, the amplitude noise of the laser source will be effectively suppressed, which results in increased sensitivity.

In an experiment using the adaptive interferometer according to the preferred embodiment of our invention with the photorefractive crystal of Bi₁₂TiO₂₀ belonging to the 23 group of symmetry, an example showing the sensitivity and efficiency of the present invention can be seen. We set forth below the conditions and results thereof by way of example in order to further describe our invention:

### EXAMPLE

The photorefractive crystal 22 of Bi₁₂TiO₂₀ was cut in the parallelepiped shape similar to that shown in FIG. 2. The input face polished to the optical quality is orthogonal to the crystallographic axis <110>. The thickness, L, of the crystal is equal to 1.97 mm. Gold electrodes were evaporated onto the faces that are orthogonal to the crystallographic axis <\overline{1}10>. The distance between electrodes is equal to 1.95 mm. The third dimension of the crystal (along to the axis <001>) is equal to 5.48 mm.

Further characterization of the photorefractive crystal 22 was carried out in the interferometer setup similar to that shown in FIG. 3, embodiment 54. In this characterization, a rough vibrating surface of a loudspeaker diffuser served as a surface under study 18. The loudspeaker was connected with a standard signal generator for excitation of diffuser vibrations at the frequency range 20 Hz-2 kHz. A high-voltage generator 56 electrically connected with the electrodes 58 of the photorefractive crystal 22 generated bipolar alternating voltage of square-wave form. The repetition frequency of the voltage pulses was about 70 Hz and their amplitude varied in the range of 0-5 kV.

The laser source 14 was a Spectra Physics He—Ne laser, Model 127-35, emitting a coherent, linearly polarized beam 12 at a wavelength λ=632 nm with output power of 25 mW. The beam 12 was divided into two mutually coherent parts 12a and 12b by a beam-splitter with the ratio of 50:50. The beam part 12a was directed onto the loudspeaker diffuser 18 and the scattered light was collected onto the input surface of the photorefractive crystal 22 by a lens 24. A polarizer 26 installed between the lens 24 and crystal 22 provides the linear polarization state of the object beam 28. The polarizer 26 is mounted into a rotational stage allowing us to vary the polarization angle ψ. The beam part 12b was directed onto the input surface of the photorefractive crystal 22 after passing through a quarter-wave plate 34. A quarter-wave plate 34 was also mounted into a rotational stage providing possibility to change the elliptical polarization state of the reference beam 32. The plane of incidence of both the object and reference beams 28, 32 was orthogonal to the crystallographic axis <001> thus providing the vector of the dielectric-permittivity-tensor grating being parallel to both the external electric field and the axis <\overline{1}10>. Intensity of the object and reference beams 28, 32 at the input face of the crystal were 15.5 and 220 mW/cm², respectively. Thus, the input intensity ratio R was about 14. The average angle θ between the object and reference beams is about 20°.

The light beam 42 emerged from the photorefractive crystal in the direction of the transmitted object beam is collected into a photo-detector 44 by a lens 46. A Hewlet Packard Digitizing Oscilloscope, Model 54501A (not shown in FIG. 3), measured the electrical signal from the photodetector 44.

The response time of the Bi₁₂TiO₂₀ crystal was measured to be about 0.07 s when the reference and object beams with total intensity of 235 mW/cm² illuminate the crystal. Thus, vibrations of the loudspeaker diffuser at the frequency of 1.34 kHz (with the oscillation period of 0.75 ms, which is much smaller than the crystal response time) introduce a transient phase shift between the object and reference beams. The loudspeaker was independently calibrated and the amplitude of the phase-shift oscillations was set to be equal to 0.24 radians.

We have found that the intensity of the beam 42 is modulated in time at the frequency of the loudspeaker oscillations either without external field on the crystal or under alternating electric field, if the reference beam is circularly polarized and the object beam is linearly polarized parallel to the axis <001>. This is a solid prove that small transient phase modulations is linearly transferred into the intensity modulation.

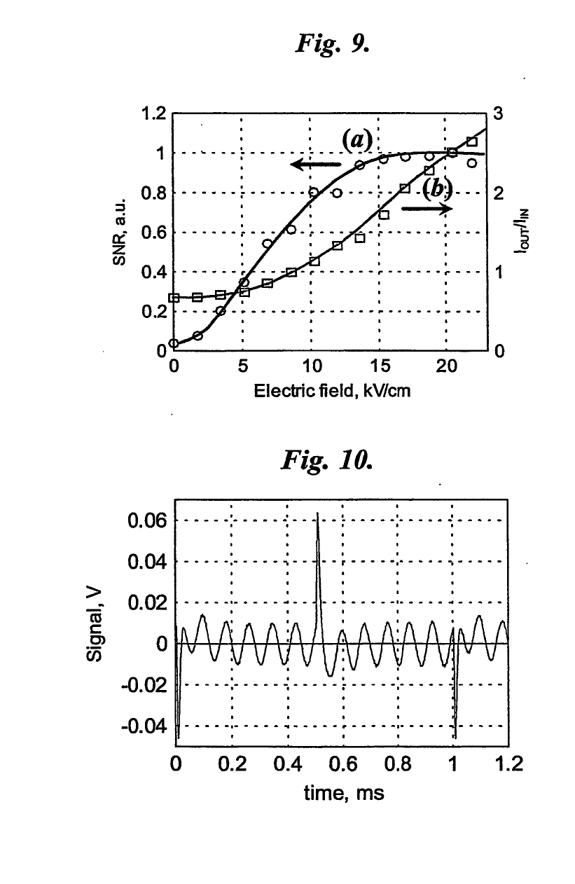

It was also found that the intensity-modulation amplitude depends on the polarization states of the reference and object beams. Under 20 kV/cm of the external electric field, the maximal intensity modulation is achieved when the object beam is linearly polarized parallel to the axis <001> and the reference beam is elliptically modulated with the ellipticity of 0.38 and the inclination angle of 34°. FIG. 9 (curve a) shows in arbitrary units the ratio of the measured amplitude of the intensity modulation to the square root of the average intensity, which represents the signal-to-noise ratio, as a function of the external electric field. One can see 26-folds growth of SNR when the external field changes from 0 to 20 kV/cm.

Simultaneously, the average intensity of the beam 42 is increases 4 times. Total optical losses of the object beam transmitted through the crystal (including absorption and reflection from the surfaces) are 34%. FIG. 9 (curve b) shows the ratio of the average intensity of the beam 42 to the intensity of the object beam 28 as a function of the external electric field. The net amplification of the signal beam at 20 kV/cm is about 2.6.

FIG. 10 shows an oscilloscope trace of the electric signal from the photo-detector 44, when the phase of the of the object beam is modulated at the frequency of 12 kHz with the amplitude of 0.12 radians and an alternating electric field of the square-wave form with the amplitude of 10 kV/cm and repetition frequency of 1 kHz is applied to the crystal. Sharp peaks in the trace of FIG. 10 reflect a reaction of the crystal on the switching of the electric-field sign. One can see in FIG. 10 that the output signal is modulated at the frequency of the input phase modulation and there is no signal-phase flip during switching of the external-field sign.

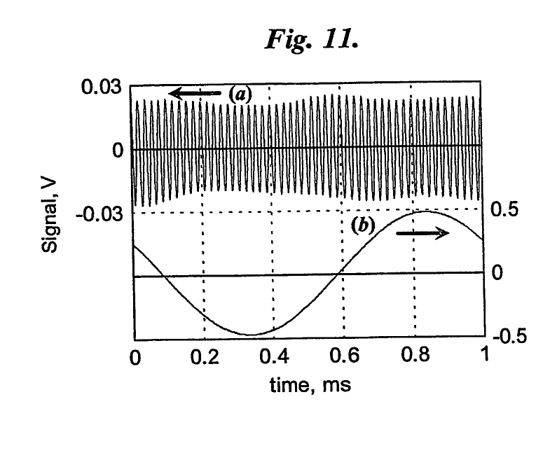

FIG. 11 shows an oscilloscope trace of the electric signal from the photo-detector 44 (trace a), when the phase of the of the object beam is modulated at the frequency of 50 kHz with the amplitude of 0.12 radians and an alternating electric field of the sinusoidal form (trace b) with the amplitude of 15 kV/cm and frequency of 1 kHz is applied to the crystal. As seen in FIG. 11, we have unexpectedly found that the rate of the phase-to-intensity transformation is almost independent on the current magnitude and sign of the external electric field if it is of the sinusoidal form, but this rate is much higher than that in the case of the grating recording without external field.

Although there has been hereinabove described a method for detection of transient phase shifts in any optical wavefront, for the purpose of illustrating the manner in which the invention may be used to advantage, it will be appreciated that the invention is not limited thereto. Accordingly, all modifications, variations, or equivalent arrangements which may occur to those skilled in the art, should be considered to be within the scope of the invention as defined in the appended claims.

1. A method for detecting transient phase shifts in an object laser beam of predetermined frequency having an arbitrary wavefront, said method comprising includes the steps of:
directing said object laser beam to cross a second reference laser beam coherent with said object beam into an oriented photorefractive crystal belonging to the crystal symmetry group of \overline{4}3m or 23;
setting the polarization state of said object beam and said reference beams to be elliptical and different one from other;
causing said object laser beam to interfere with said reference beam inside the said photorefractive crystal so as to form a dielectric-permittivity-tensor grating diffracting said reference beam into said object beam and vice versa; and
directing a beam transmitted through the said photorefractive crystal in the direction of a transmitted object beam onto a photo-detector to result in an electrical output signal that is representative of the transient phase shift in the object laser beam.

2. The method of claim 1 wherein the crystallographic axes of said photorefractive crystal are positioned so as the axis <110> is almost parallel to a bisector of an angle between an average propagation direction of said object beam and an average propagation direction of said reference beam, while the axis <001> is orthogonal to the plane containing the average propagation directions of said reference and object beams.

3. The method of claim 2 wherein the polarization state of said reference beam is set circular and the polarization state of said object beam is set linear with the plane of the polarization making an angle ψ equal to
$$- \frac{1}{2} arctan ( \frac{ρ}{\sqrt{{ρ}^{2} + {κ}^{2}}} tan ( L \sqrt{{ρ}^{2} + {κ}^{2}} ) )$$
in respect to either the axis <001> or the axis <110>, where L is the crystal thickness, ρ is the optical rotatory power, and κ is the coupling constant of said object and reference beams through the dielectric-permittivity-tensor grating.

4. The method of claim 2 wherein the polarization state of said reference beam is set linear with the plane of the polarization making an angle ψ equal to
$$- \frac{1}{2} arctan ( \frac{ρ}{\sqrt{{ρ}^{2} + {κ}^{2}}} tan ( L \sqrt{{ρ}^{2} + {κ}^{2}} ) )$$
in respect to either the axis <001> or the axis <\overline{1}10> and the polarization state of said object beam is set circular, where L is the crystal thickness, ρ is the optical rotatory power, and κ is the coupling constant of said object and reference beams through the dielectric-permittivity-tensor grating.

5. The method of claim 1 or 2 wherein an alternating electric field with a period shorter than the response time of the said photorefractive crystal is applied across said photorefractive crystal so as to increase the amplitude of said dielectric-permittivity-tensor grating.

6. The method of claim 5 wherein the alternating electric field is applied almost orthogonal to both <110> and <001> axis, and the polarization states of said object beam and said reference beam are set different one from other so as to maximize the ratio of the output signal variation of the said photo-detector caused by the transient phase shift and the square root of the average output signal of said photo-detector measured in absence of the transient phase shift.

7. The method of claim 5 wherein said alternating electric field has a square-wave waveform.

8. The method of claim 6 wherein said alternating elective field has a square-wave waveform.

9. The method of claim 5 wherein said alternating electric field has a sinusoidal waveform.

10. The method of claim 6 wherein said alternating electric field has a sinusoidal waveform.

11. The method of claim 1 wherein said object beam is split into a first object beam and a second object beam with almost mutually orthogonal polarization states and with almost equal light power; said first and second object beams are caused to interfere with said reference beam inside the said photorefractive crystal so as to form two different dielectric-permittivity-tensor gratings diffracting said reference beam into both said first object beam and said second object beam; optical beams transmitted through the said photorefractive crystal in the directions of said first object beam and said second object beam are directed onto the first and second photo-detectors, respectively, to result in an electrical signals which are electronically subtracted one from another forming an electrical output signal that is representative of the transient phase shift in the said object laser beam.

12. The method of claim 11 wherein the reference beam is either expanded or split to overlap said first object beam and said second object beam; the crystallographic axes of said photorefractive crystal are positioned so as the axis <110> is almost parallel to a bisector of an angle between an average propagation direction of said first object beam and an average propagation direction of said reference beam, and the same axis <110> is almost parallel to a bisector of an angle between an average propagation direction of said second object beam and an average propagation direction of said reference beam, while the axis <001> is almost orthogonal to the plane containing the average propagation directions of said reference and first object beams and the same axis <001> is almost orthogonal to the plane containing the average propagation directions of said reference and second object beams.

13. The method of claim 12 wherein the polarization state of said reference beam is set circular, the polarization state of said first and second object beam are set linear; the plane of polarization of the first object beam makes an angle of
$$- \frac{1}{2} arctan ( \frac{ρ}{\sqrt{{ρ}^{2} + {κ}^{2}}} tan ( L \sqrt{{ρ}^{2} + {κ}^{2}} ) )$$
in respect to the axis <001> and plane of polarization of the second object beam makes the same angle in respect to the axis <\overline{1}10>, where L is the crystal thickness, ρ is the optical rotatory power, and θ is the coupling constant of said object and reference beams through the dielectric-permittivity-tensor gratings.

14. The method of claim 12 wherein the polarization state of said reference beam is set linear with the plane of the polarization making an angle ψ equal to
$$- \frac{1}{2} arctan ( \frac{ρ}{\sqrt{{ρ}^{2} + {κ}^{2}}} tan ( L \sqrt{{ρ}^{2} + {κ}^{2}} ) )$$
in respect to either the axis <001> or the axis <\overline{1}10> and the polarization state of said first and second object beams are set right-hand circular and left-hand circular, respectively, where L is the crystal thickness, ρ is the optical rotatory power, and θ is the coupling constant of said object and reference beams through the dielectric-permittivity-tensor gratings.

15. The method of claim 9 or 10 wherein an alternating electric field with a period shorter than the response time of the said photorefractive crystal is applied across said photorefractive crystal so as to increase the amplitude of said dielectric-permittivity-tensor gratings.

16. The method of claim 15 wherein the alternating electric field is applied almost orthogonal to both <110> and <001> axis, and the polarization states of said first object beam and said reference beam are set different one from other so as to maximize the ratio of the output signal variation of the said first photo-detector caused by the transient phase shift and the square root of the average output signal of said first photo-detector measured in absence of the transient phase shift.

17. The method of claim 15 wherein said alternating electric field has a square-wave waveform.

18. The method of claim 16 wherein alternating electric field has a square-wave waveform.

19. The method of claim 13 wherein said alternating electric field has a sinusoidal waveform.

20. The method of claim 16 wherein said alternating electric field has a sinusoidal waveform.

21. The method of claim 1 further comprising the steps of reflecting a laser beam from a surface in order to produce said object laser beam and subjecting said surface to either acoustic or ultrasonic energy in order to cause a transient phase shift in the object laser beam which is proportional to the out-of-plane surface displacement caused by the acoustic or ultrasonic energy.

22. The method of claim 1 further comprising the steps of transmitting a laser beam through an optical fiber in order to produce said object laser beam and subjecting at least a part of said optical fiber to either acoustic or ultrasonic energy in order to cause transient phase shift in the object laser beam which is proportional to transient change of the propagation length of said optical fiber caused by the acoustic or ultrasonic energy.

23. An apparatus for sensing transient displacement on a material having a test surface, said apparatus comprising:
a light generator for generating a coherent polarized beam of light having a predetermined frequency;
a beam-splitting for receiving said generated light beam, splitting said generated light beam into at least a first light beam and a second light beam, and for directing said first light beam onto a test rough or specular surface capable of at least scattering or reflecting said first beam;
a first polarization transformer, positioned to receive at least a portion of said scattered or reflected first light beam, for setting an elliptical polarization state of the said first beam;
a second polarization transformer, positioned to receive at least a portion of said second light beam, for setting an elliptical polarization state of the said second beam, which is different from the polarization state of the said first beam;
a photorefractive crystal belonging to the either \overline{4}3m or 23 symmetry group with a receiving surface for receiving at least a portion of said first light beam from said first polarization transformer at a first angle relative to said photorefractive crystal receiving surface, and for receiving said second light beam from said second polarization transformer at a second angle relative to said photorefractive crystal receiving surface, for interfering said first and said second beams and for producing at least one set of co-propagating light beams comprising at least a portion of said first beam and said second beam received by said photorefractive crystal receiving surface;
an optical collector means for collecting said set of co-propagating light beams and for directing said set of co-propagating light beams into a photo-detector means; and,
a photo-detector, positioned to receive said set of co-propagating light beams from said photorefractive crystal, for producing an electrical output signal that is representative of a transient displacement of the test surface.

24. The apparatus of claim 23 wherein said photorefractive crystal has at least two electrodes for applying electric field and the apparatus further comprises an electrical signal generator for applying an alternating voltage to the electrodes of the said photorefractive crystal with a period shorter than a response time of the said photorefractive crystal.

25. The apparatus of claim 20 wherein said alternating voltage has a square-wave waveform.

26. The apparatus of claim 20 wherein said alternating voltage has sinusoidal waveform.

27. An apparatus for sensing transient displacement on a material having a test surface, said apparatus comprising:
a light generator for generating a coherent polarized beam of light having a predetermined frequency;
a beam-splitter means for receiving said generated light beam, splitting said generated light beam into at least a first light beam and a second light beam, and for directing said first light beam onto a test rough or specular surface capable of at least scattering or reflecting said first beam;
a first optical collector for collecting at least a portion of said scattered or reflected first light beam and for directing the portion;
a polarization beam-splitting cube positioned to receive at least the portion of said scattered or reflected first light beam and to split said scattered or reflected first light beam portion into an third and fourth beams with mutually orthogonal polarization states;
a first polarization transformer, positioned to receive at least a portion of said third light beam, for setting a polarization state of the said third beam;
a second polarization transformer, positioned to receive at least a portion of said fourth light beam, for setting a polarization state of the fourth beam;
a third polarization transformer, positioned to receive at least a portion of said second light beam, for setting a polarization state of the second beam;
a photorefractive crystal belonging to the either \overline{4}3m or 23 symmetry group with a receiving surface for receiving at least a portion of said third light beam from said first polarization transformer at a first angle relative to said photorefractive crystal receiving surface, and for receiving said second light beam from said third polarization transformer at a second angle relative to said photorefractive crystal receiving surface, for interfering said third and said second beams and for producing first set of co-propagating light beams comprising at least a portion of said third beam and said second beam received by said photorefractive crystal receiving surface, and for receiving at least a portion of said fourth light beam from said second polarization transformer at a third angle relative to said photorefractive crystal receiving surface, and for receiving said second light beam from said third polarization transformer at a second angle relative to said photorefractive crystal receiving surface, for interfering said fourth and said second beams and for producing second set of co-propagating light beams comprising at least a portion of said fourth beam and said second beam received by said photorefractive crystal receiving surface;
a second optical collector for collecting said first set of co-propagating light beams and for directing said first set of co-propagating light beams;
a third optical collector for collecting said second set of co-propagating light beams and for directing said second set of co-propagating light beams;
a first and a second photo-detector, positioned to receive said first and second sets of co-propagating light beams from said photorefractive crystal, respectively for producing electrical output signals; and,
an electronic circuit for receiving said electrical signals for producing difference electrical signal that is representative of a transient displacement of the test surface.

28. The apparatus of claim 27 wherein said photorefractive crystal has at least two electrodes for applying electric field and the apparatus further comprises an electrical signal generator for applying an alternating voltage to the electrodes of the said photorefractive crystal with a period shorter than the response time of the said photorefractive crystal.

29. The apparatus for sensing transient displacement on a material having a test rough surface of claim 24 wherein said alternating voltage has a square-wave waveform.

30. The apparatus of claim 24 wherein said alternating voltage has sinusoidal waveform.

31. The apparatus of any one of claims 23, 24, 25, and 26 further comprising a second beam-splitter means for receiving at least a portion of said second beam from the said third polarization transformer and for splitting the said second beam into a fifth and sixth beams providing that at least a portion of said fifth beam is received by the photorefractive crystal receiving surface at said second angle relative to said photorefractive crystal receiving surface, for interfering said third and said fifth beams and for producing first set of co-propagating light beams comprising at least a portion of said third beam and said fifth beam, and providing that at least a portion of said sixth beam is received by the said photorefractive crystal receiving surface at either said second a fourth angle relative to said photorefractive crystal receiving surface, for interfering said fourth and said sixth beams and for producing second set of co-propagating light beams comprising at least a portion of said fourth beam and said sixth beam.

32. An apparatus for sensing of transient change on an optical fiber, said apparatus comprising:
a light generating for generating a coherent polarized beam of light having a predetermined frequency;
a beam-splitting for receiving said generated light beam, splitting said generated light beam into at least a first light beam and a second light beam, and for directing said first light into an optical fiber;
a first polarization transformer positioned to receive at least a portion of said first light beam transmitted through the said optical fiber, for setting an elliptical polarization state of the said first beam;
a second polarization transformer positioned to receive at least a portion of said second light beam, for setting an elliptical polarization state of the said second beam, which is different from the polarization state of the said first beam;
a photorefractive crystal belonging to the either \overline{4}3m or 23 symmetry group with a receiving surface for receiving at least a portion of said first light beam from said first polarization transformer at a first angle relative to said photorefractive crystal receiving surface, and for receiving said second light beam from said second polarization transformer at a second angle relative to said photorefractive crystal receiving surface, for interfering said first and said second beams and for producing at least one set of co-propagating light beams comprising at least a portion of said first beam and said second beam received by said photorefractive crystal receiving surface;
a optical collector means for collecting said set of co-propagating light beams and for directing said set of co-propagating light beams; and
a photo-detector, positioned to receive said one set of co-propagating light beams from said photorefractive crystal, for producing an electrical output signal that is representative of a transient change of the propagation length of said optical fiber.

33. The apparatus of claim 32 wherein said photorefractive crystal has at least two electrodes for applying electric field and the apparatus further comprises an electrical signal generator for applying an alternating voltage to the electrodes of the said photorefractive crystal with a period shorter than the response time of the said photorefractive crystal.

34. The apparatus of claim 29 wherein said alternating voltage has a square-wave waveform.

35. The apparatus of claim 34 wherein said alternating voltage has sinusoidal waveform.

36. An apparatus for sensing transient change on an optical fiber, said apparatus comprising:
a light generator for generating a coherent polarized beam of light having a predetermined frequency;
a beam-splitter for receiving said generated light beam, splitting said generated light beam into at least a first light beam and a second light beam, and for directing said first light beam into an optical fiber;
a polarization beam-splitting cube positioned to receive at least a portion of first light beam transmitted through the said optical fiber and for splitting said transmitted beam into a third and fourth beams with mutually orthogonal polarization states;
a first polarization transformer positioned to receive at least a portion of said third light beam, for setting a polarization state of the said third beam;
a second polarization transformer positioned to receive at least a portion of said fourth light beam, for setting a polarization state of the said fourth beam;
a third polarization transformer positioned to receive at least a portion of said second light beam, for setting a polarization state of the said second beam;
a photorefractive crystal belonging to the either \overline{4}3m or 23 symmetry group with a receiving surface for receiving at least a portion of said third light beam from said first polarization transformer at a first angle relative to said photorefractive crystal receiving surface, and for receiving said second light beam from said third polarization transformer at a second angle relative to said photorefractive crystal receiving surface, for interfering said third and said second beams and for producing first set of co-propagating light beams comprising at least a portion of said third beam and said second beam received by said photorefractive crystal receiving surface, and for receiving at least a portion of said fourth light beam from said second polarization transformer at a third angle relative to said photorefractive crystal receiving surface, and for receiving said second light beam from said third polarization transformer at a second angle relative to said photorefractive crystal receiving surface, for interfering said fourth and said second beams and for producing second set of co-propagating light beams comprising at least a portion of said fourth beam and said second beam received by said photorefractive crystal receiving surface;
a first optical collector for collecting said first set of co-propagating light beams and for directing said first set of co-propagating light beam;
a second optical collector for collecting said second set of co-propagating light beams and for directing said second set of co-propagation light beams;
first and second photo-detectors, positioned to receive said first and second sets of co-propagating light beams from said photorefractive crystal respectively, for producing electrical output signals; and,
an electronic circuit to receive said electrical signals for producing difference electrical signal that is representative of a transient change of the propagation length of said optical fiber.

37. The apparatus of claim 36 wherein said photorefractive crystal has at least two electrodes for applying electric an field and the apparatus further comprises electrical signal generator for applying an alternating voltage to the electrodes of the said photorefractive crystal with a period shorter than the response time of the said photorefractive crystal.

38. The apparatus of claim 33 wherein said alternating voltage has a square-wave waveform.

39. The apparatus of claim 33 wherein said alternating voltage has sinusoidal waveform.

40. The apparatus of any one of claims 32, 33, 34, and 35 which further comprises a second beam-splitter for receiving at least a portion of said second beam from the said third polarization transformer means and for splitting the said second beam into a fifth and sixth beams providing that at least a portion of said fifth beam is received by the said photorefractive crystal receiving surface at said second angle relative to said photorefractive crystal receiving surface, for interfering said third and said fifth beams and for producing first set of co-propagating light beams comprising at least a portion of said third beam and said fifth beam, and providing that at least a portion of said sixth beam is received by the said photorefractive crystal receiving surface at either said second a fourth angle relative to said photorefractive crystal receiving surface, for interfering said fourth and said sixth beams and for producing second set of co-propagating light beams comprising at least a portion of said fourth beam and said sixth beam.
